(19) United States
(12) Patent Application Publication
(10) Pub. No.: US 2019/0252791 A1
(43) Pub. Date: Aug. 15, 2019

(54) Inflatable Radar Decoy System and Method

(71) Applicant: The Boeing Company, Chicago, IL (US)

(72) Inventor: Kosal Svy, Covington, WA (US)

(21) Appl. No.: 15/892,492

(22) Filed: Feb. 9, 2018

(51) Int. Cl. H01Q 15/16; F41H 11/02

(52) U.S. Cl. CPC H01Q 15/163; F41H 11/02

(57) ABSTRACT

A method and system for reflecting a radar signal. First, an event for a platform is detected. Next, a number of decoy units is launched from a launcher system for the platform, wherein a decoy unit comprises an inflatable radar decoy and an inflator cartridge configured to inflate the inflatable radar decoy. Then, the inflatable radar decoy is inflated using the inflator cartridge after launching the decoy unit from the launcher system for the platform.

### BACKGROUND INFORMATION

### 1. Field

The present disclosure relates generally to vehicles and, in particular, to radar decoys for vehicles. Still more particularly, the present disclosure relates to a method, an apparatus, and a system for an inflatable radar decoy for a vehicle.

### 2. Background

Aircraft can employ defensive countermeasure mechanisms to avoid detection, attack, or some combination thereof by adversaries using radar. Chaff is one type of radar countermeasure. The chaff acts as a decoy for an aircraft. The chaff comprises small pieces of aluminum, glass fiber, or plastic, which, when deployed, appears as a cluster of targets. With larger aircraft such as aerial refueling tankers and air surveillance aircraft, the chaff can be less effective as compared to when this type of decoy system is used with smaller aircraft, such as fighters. For example, the chaff may not provide a radar cross-section with a large enough size for larger aircraft. Further, this type of countermeasure system can be rejected by the radar's clutter suppression filter due to lack of apparent velocity being present soon after the chaff is dispensed.

Electronic countermeasures or active decoys can be effectively used for larger aircraft. An electronic countermeasure device is an active electronic system that is designed to trick or deceive a radar system for an offensive device such as a missile. With this type of countermeasure system, the aircraft can be made to appear as separate targets, disappear, or move randomly. This type of countermeasure can be effectively used to protect an aircraft from guided missiles. These types of systems, however, are expensive and add to the weight and power use in an aircraft and often have frequency limitations or angular coverage limitations.

Therefore, it would be desirable to have a method and apparatus that take into account at least some of the issues discussed above, as well as other possible issues. For example, it would be desirable to have a method and apparatus that overcome a technical problem with obtaining the desired size for a radar cross-section using currently available radar countermeasure systems.

### SUMMARY

An embodiment of the present disclosure provides a radar countermeasure comprising a number of decoy units and a launcher system for a platform. A decoy unit in the number of decoy units comprises an inflatable radar decoy and an inflator cartridge configured to inflate the inflatable radar decoy. The launcher system is configured to hold and launch the number of decoy units.

Another embodiment of the present disclosure provides a number of decoy units. A decoy unit in the number of decoy units comprises an inflatable radar decoy and an inflator cartridge configured to inflate the inflatable radar decoy in which the inflatable radar decoy comprises an inflatable bladder that is radio frequency transparent and a number of corner reflectors located inside of the inflatable bladder.

Yet another embodiment of the present disclosure provides a method for reflecting a radar signal. First, an event for a platform is detected. Next, a number of decoy units is launched from a launcher system for the platform, wherein a decoy unit comprises an inflatable radar decoy and an inflator cartridge configured to inflate the inflatable radar decoy. Then, the inflatable radar decoy is inflated using the inflator cartridge after launching the decoy unit from the launcher system for the platform.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial illustration of a radar decoy environment in accordance with an illustrative embodiment;

FIG. 2 is a pictorial illustration of another radar decoy environment in accordance with an illustrative embodiment;

FIG. 3 is an illustration of a block diagram of a radar decoy environment in accordance with an illustrative embodiment;

FIG. 4 is an illustration of a block diagram of an inflator cartridge in accordance with an illustrative embodiment;

FIG. 5 is an illustration of a block diagram of an inflatable radar decoy unit in accordance with an illustrative embodiment;

FIG. 6 is an illustration of a radar countermeasure system in accordance with an illustrative embodiment;

FIG. 7 is an illustration of a deployment of an inflatable decoy in accordance with an illustrative embodiment;

FIG. 8 is an illustration of a deployed inflatable decoy in accordance with an illustrative embodiment;

FIG. 9 is an illustration of an implementation for an inflatable radar decoy in accordance with an illustrative embodiment;

FIG. 10 is an illustration of a corner reflector in accordance with an illustrative embodiment;

FIG. 11 is an illustration of a Doppler shift mechanism in accordance with an illustrative embodiment;

FIG. 12 is an illustration of a flowchart of a process for reflecting a radar signal in accordance with an illustrative embodiment;

FIG. 13 is an illustration of a block diagram of an aircraft manufacturing and service method in accordance with an illustrative embodiment; and

FIG. 14 is an illustration of a block diagram of an aircraft in which an illustrative embodiment may be implemented.

### DETAILED DESCRIPTION

The illustrative embodiments recognize and take into account one or more different considerations. For example, the illustrative embodiments recognize and take into account that currently used greater decoy systems such as chaff may not provide a desired amount of protection from detection by radar systems. Those embodiments recognize and take into account that if the size of an aircraft increases, the radar cross-section for the aircraft also increases. The illustrative embodiments recognize and take into account that in currently used chaff systems, the chaff launched from an aircraft may not provide a radar cross-section or a Doppler shift that is sufficient to act as a decoy for an aircraft.

The illustrative embodiments also recognize and take into account that electronic countermeasures have a size and weight that may be greater than radar countermeasure systems such as chaff. Those embodiments recognize and take into account that the increased size and weight may be greater than desired for an aircraft. Further, those embodiments also recognize and take into account that electronic countermeasures also have power and cooling requirements that may be greater than desired.

Thus, the illustrative embodiments provide a method, an apparatus, and a system for reflecting a radar signal in a manner that acts as a decoy for an aircraft. In one illustrative example, a process is present in which a number of decoy units is launched from a launcher system for the platform. As used herein, “a number of,” when used with reference to items, means one or more items. For example, “a number of decoy units” is one or more decoy units.

A decoy unit in the number of decoy units comprises an inflatable radar decoy and an inflator cartridge. The inflatable radar decoy is inflated using the inflator cartridge after launching the decoy unit from the launcher system for the platform. This process enables reducing detection of the platform by a radar system.

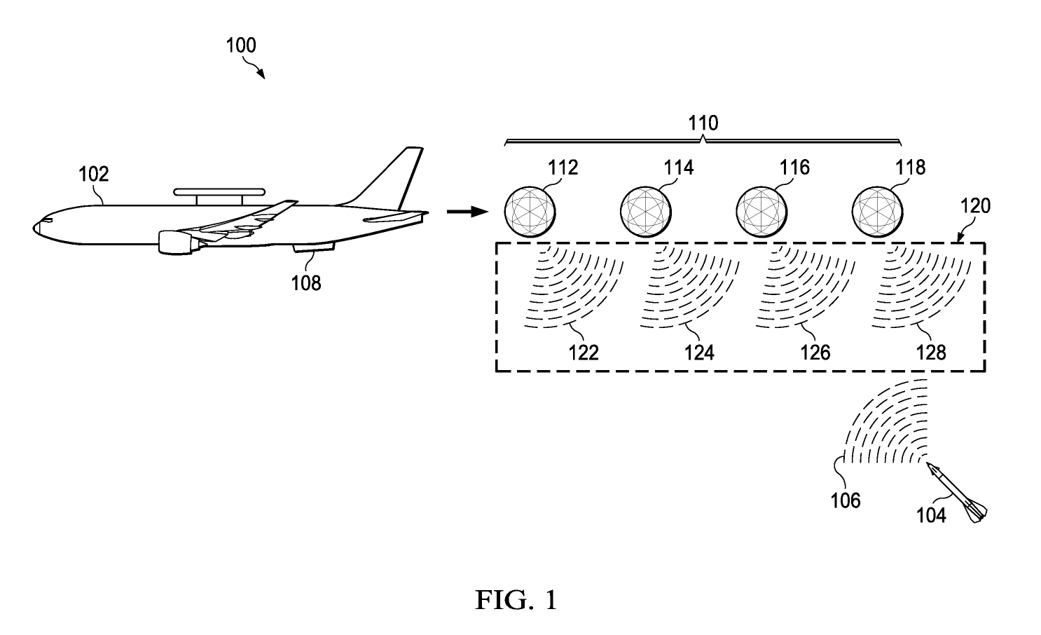

With reference now to the figures and, in particular, with reference to FIG. 1, a pictorial illustration of a radar decoy environment is depicted in accordance with an illustrative embodiment. Radar decoy environment 100 includes surveillance aircraft 102 and missile 104 which employs radar signal 106 to detect targets.

As depicted, surveillance aircraft 102 has radar countermeasure system 108. As depicted in this figure, radar countermeasure system 108 has launched inflatable radar decoys 110. In this illustrative example, inflatable radar decoys 110 include inflatable radar decoy 112, inflatable radar decoy 114, inflatable radar decoy 116, and inflatable radar decoy 118.

In response to radar signal 106 being transmitted by missile 104, inflatable radar decoys 110 generate radar returns 120. As depicted, radar returns 120 include radar return 122 from inflatable radar decoy 112; radar return 124 from inflatable radar decoy 114; radar return 126 from inflatable radar decoy 116; and radar return 128 from inflatable radar decoy 118. These radar returns attract missile 104 to one or more of inflatable radar decoys 110.

In this illustrative example, inflatable radar decoys 110 have a radar cross-section that is sufficiently large to attract missile 104 such that missile 104 does not target surveillance aircraft 102. As depicted, inflatable radar decoys 110 take up less space in surveillance aircraft 102 when in an uninflated state. In the inflated state, inflatable radar decoys 110 have a cross-section that is large relative to the size of inflatable radar decoys 110 in the uninflated state. As a result, inflatable radar decoys 110 have a more desirable footprint for use in radar countermeasure system 108 in surveillance aircraft 102.

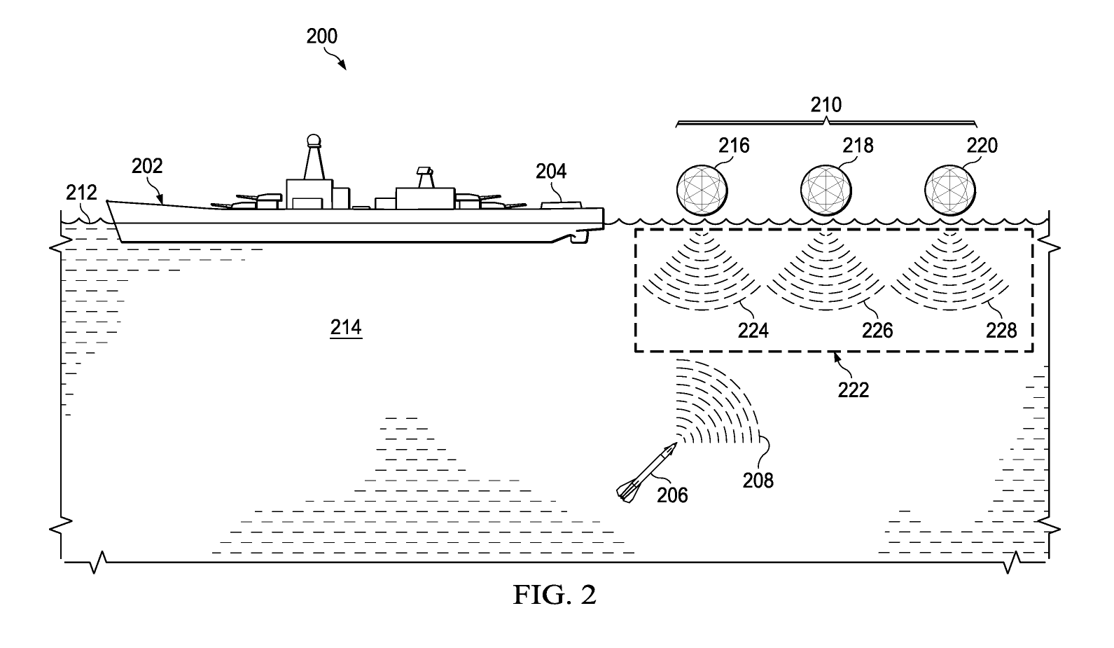

With reference next to FIG. 2, a pictorial illustration of another radar decoy environment is depicted in accordance with an illustrative embodiment. Radar decoy environment 200 includes surface ship 202, which has radar countermeasure system 204. As depicted, missile 206 is a potential threat to surface ship 202. Missile 206 uses radar signal 208 to locate targets.

In this example, radar countermeasure system 204 has deployed inflatable radar decoys 210 onto surface 212 of water 214. As depicted, inflatable radar decoys 210 include inflatable radar decoy 216, inflatable radar decoy 218, and inflatable radar decoy 220.

Inflatable radar decoys 210 generate radar returns 222 in response to radar signal 208. For example, radar return 224 originates from inflatable radar decoy 216, radar return 226 originates from inflatable radar decoy 218, and radar return 228 originates from inflatable radar decoy 220. In this illustrative example, inflatable radar decoys 210 generate radar returns 222 with a radar cross-section that is sufficiently large to attract missile 206 away from surface ship 202.

The pictorial illustrations of radar decoy environment 100 in FIG. 1 and radar decoy environment 200 in FIG. 2 are provided as examples of equal environments in which radar countermeasure systems may be implemented in accordance with an illustrative embodiment. These illustrations are not meant to limit the manner in which other illustrative embodiments can be implemented. For example, other numbers of inflatable radar decoys may be used instead of four inflatable radar decoys in FIG. 1 and three inflatable radar decoys in FIG. 2.

In other illustrative examples, one, seven, 10, or some other number of inflatable radar decoys can be used. Further, these inflatable radar decoys may be used to hide, mask, or otherwise take attention away from a platform from other objects other than a missile. For example, these inflatable radar decoys may be used against stationary radar systems, radar-guided antiaircraft guns, torpedoes, and other types of radar-based systems.

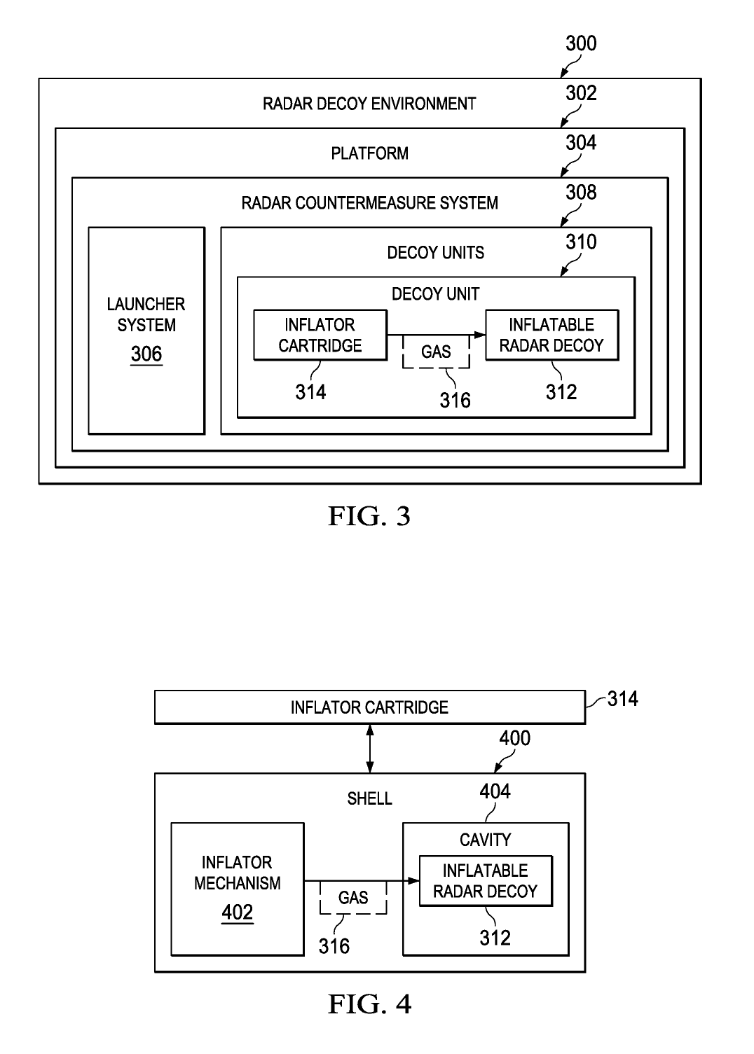

With reference now to FIG. 3, an illustration of a block diagram of a radar decoy environment is depicted in accordance with an illustrative embodiment. Radar decoy environment 100 in FIG. 1 and radar decor environment 200 in FIG. 2 are examples of physical implementations for radar decoy environment 300 shown in block form in this figure.

As depicted, radar decoy environment 300 includes platform 302. Platform 302 can take a number of different forms. For example, platform 302 can be a mobile platform, a stationary platform, a land-based structure, an aquatic-based structure, and a space-based structure. More specifically, platform 302 can be an aircraft, a rotorcraft, a surface ship, a tank, a personnel carrier, a train, a spacecraft, a space station, a satellite, a submarine, an automobile, a power plant, a bridge, a dam, a house, a manufacturing facility, a building, and other suitable types of platforms.

In this illustrative example, radar countermeasure system 304 is associated with platform 302. When one component is “associated” with another component, the association is a physical association. For example, a first component, radar countermeasure system 304, may be considered to be physically associated with a second component, platform 302, by at least one of being secured to the second component, bonded to the second component, mounted to the second component, welded to the second component, fastened to the second component, or connected to the second component in some other suitable manner. The first component also may be connected to the second component using a third component. The first component may also be considered to be physically associated with the second component by being formed as part of the second component, an extension of the second component, or both.

As depicted, radar countermeasure system 304 comprises launcher system 306 and a number of decoy units 308. Decoy unit 310 in the number of decoy units 308 comprises inflatable radar decoy 312 and inflator cartridge 314 configured to inflate inflatable radar decoy 312.

In this illustrative example, inflatable radar decoy 312 has a shape selected from a group comprising a sphere, a pyramid, a cube, an octahedron, a dodecahedron, a cylinder, or some other suitable shape. Inflator cartridge 314 is configured to inflate inflatable radar decoy 312 with gas 316 selected from a group comprising air, nitrogen, helium, argon, and some other suitable gas. Gas 316 can be generated from a compressed gas, a chemical, or some other mechanism. For example, compressed air cylinders or exothermic chemical units for airbags can be used to inflate inflatable radar decoy 312.

Launcher system 306 is platform 302. Launcher system 306 is configured to hold and launch the number of decoy units 308. Launcher system 306 is further configured to hold and launch at least one of a chaff, a flare, or some other object in addition to the number of decoy units. In other words, the number of decoy units 308 have shape and size that allows the number of decoy units 308 to be used with currently available or installed launcher systems that are used for launching objects such as chaff or flares. With this type of implementation, platforms that are currently configured to use flares or chaff can be more easily reconfigured to use decoy units 308.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

With reference next to FIG. 4, an illustration of a block diagram of an inflator cartridge is depicted in accordance with an illustrative embodiment. In the illustrative examples, the same reference numeral may be used in more than one figure. This reuse of a reference numeral in different figures represents the same element in the different figures

In this example, inflator cartridge 314 comprises shell 400. Shell 400 includes inflator mechanism 402 and cavity 404. Cavity 404 holds inflatable radar decoy 312 and is connected to inflator mechanism 402. Inflator mechanism 402 generates gas 316 to inflate inflatable radar decoy 312. In this illustrative example, inflator mechanism 402 can be selected from at least one of a compressed gas, a chemical, or some other mechanism that generates gas 316 to inflate inflatable radar decoy 312.

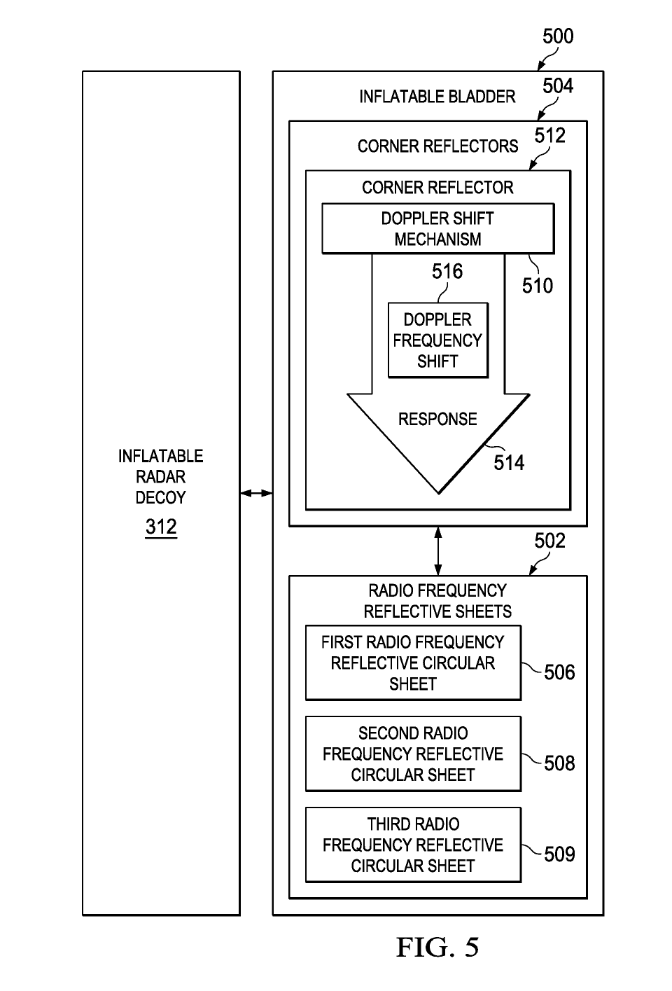

With reference next to FIG. 5, an illustration of a block diagram of an inflatable radar decoy unit is depicted in accordance with an illustrative embodiment. An example of an implementation of inflatable radar decoy 312 is depicted. In one illustrative, non-limiting example, inflatable radar decoy 312 comprises inflatable bladder 500 and a number of radio frequency reflective sheets 502.

In the illustrative example, inflatable bladder 500 is radio frequency transparent. A number of radio frequency reflective sheets 502 is attached to an interior of inflatable bladder 500. The number of radio frequency reflective sheets 502 can be configured to form a number of corner reflectors 504 located inside of inflatable bladder 500.

For example, the number of radio frequency reflective sheets 502 comprises first radio frequency reflective circular sheet 506, second radio frequency reflective circular sheet 508, and third radio frequency reflective circular sheet 509. These three radio frequency reflective circular sheets can be intersected to form eight corner reflectors within inflatable bladder 500 in which edges of the eight corner reflectors are attached to an inside surface of inflatable bladder 500 such that the eight corner reflectors are formed when inflatable bladder 500 is inflated.

In another illustrative example, decoy unit 310 in FIG. 3 can include Doppler shift mechanism 510 connected to corner reflector 512 in the number of corner reflectors 504. In this implementation, Doppler shift mechanism 510 generates response 514 to a radar signal in which response 514 includes Doppler frequency shift 516 that mimics movement of a target.

In one illustrative example, one or more technical solutions are present that overcome a technical problem with providing a large enough radar cross-section for larger aircraft such as refueling tanks or reconnaissance aircraft using commercial airplanes. As a result, one or more technical solutions may provide a technical effect of providing an inability to increase the size of the radar cross-section.

One or more technical solutions also provide a technical effect of increasing the radar cross-section while reducing the increase in size in the radar decoys. In one illustrative example, currently used larger systems for chaff or flares may be used to launch decoy units containing inflatable radar decoys with inflator cartridges. As a result, integration costs may be decreased.

Further, one or more technical solutions also may provide for rapid inflation using compressed gas, chemicals, or the mechanism in the inflator cartridge. Additionally, one or more technical solutions also include inflatable corner reflectors that can be located within the inflatable radar decoys.

The illustration of radar decoy environment 300 and the different components in this environment in FIGS. 3-5 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, radar countermeasure system 304 can include other types of countermeasure systems in addition to decoy units 308 launched from launcher system 306. For example, radar countermeasure system 304 can include chaff and electronic countermeasure mechanisms. In another illustrative example, radar decoy environment 300 may include one or more platforms in addition to platform 302 of the same or different types in which each of these platforms also is protected using a radar countermeasure system.

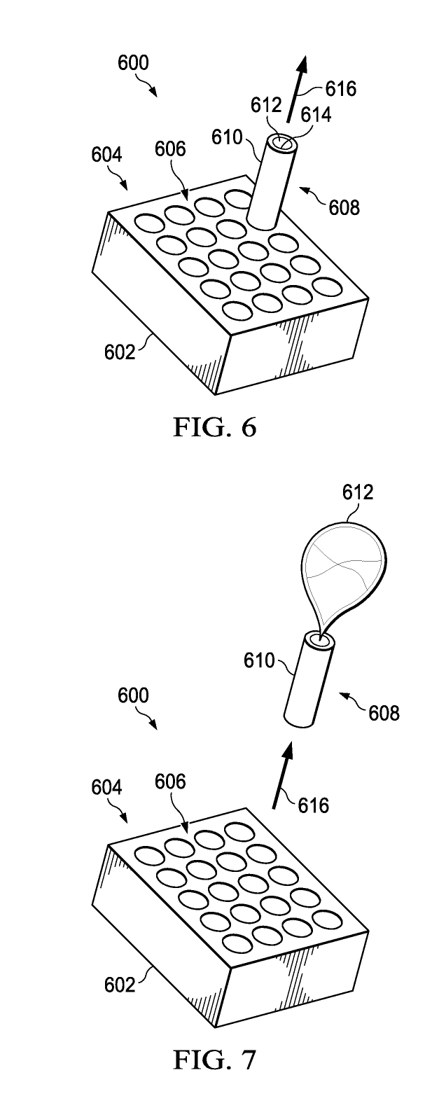

With reference to FIGS. 6-8, diagrams illustrating the deployment of a decoy unit is depicted in accordance with an illustrative embodiment. Turning now to FIG. 6, an illustration of a radar countermeasure system is depicted in accordance with an illustrative embodiment. In this illustrative example, radar countermeasure system 600 is an example of one physical implementation for radar countermeasure system 304 shown in block form in FIG. 3.

As depicted, radar countermeasure system 600 comprises launcher system 602 in a number of decoy units 604 held within slots 606 in launcher system 602. As depicted, decoy unit 608 has been launched by launcher system 602. Decoy unit 608 comprises inflator cartridge 610 and inflatable radar decoy 612 held within channel 614 of inflator cartridge 610. As depicted, decoy unit 608 is launched in the direction of arrow 616.

Turning next to FIG. 7, an illustration of a deployment of an inflatable decoy is depicted in accordance with an illustrative embodiment. In this illustrative example, decoy unit 608 has traveled in the direction of arrow 616 and has been activated to inflate inflatable radar decoy 612. In one illustrative example, inflator cartridge 610 inflates inflatable radar decoy 612 using a gas. The gas employed can be lighter than air, heavier than air, or the same weight as air depending on the particular implementation. As depicted, inflatable radar decoy 612 is shown in a partially inflated state.

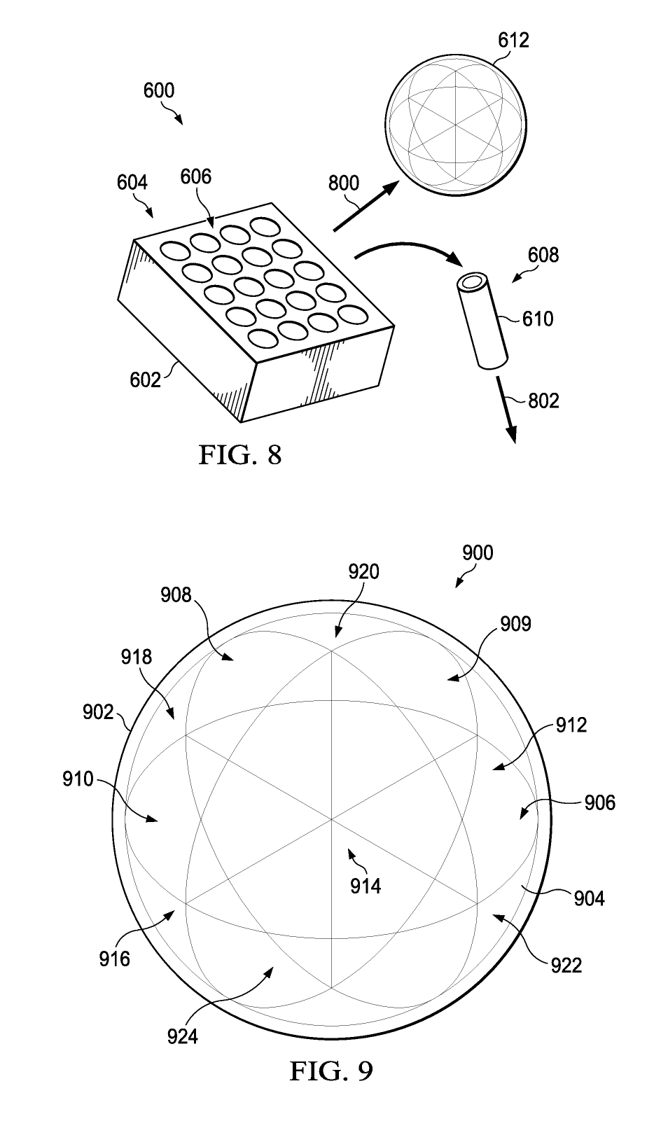

With reference to FIG. 8, an illustration of a deployed inflatable decoy is depicted in accordance with an illustrative embodiment. As depicted in this figure, inflatable radar decoy 612 is shown in an inflated state and has come detached from inflator cartridge 610. As depicted, inflatable radar decoy 612 travels in the direction of arrow 800 while inflator cartridge 610 travels in the direction of arrow 802.

With reference next to FIG. 9, an illustration of an implementation for an inflatable radar decoy is depicted in accordance with an illustrative embodiment. As depicted, inflatable radar decoy 900 is an example of a physical implementation for inflatable radar decoy 312 as shown in block form in FIGS. 3-5. Inflatable radar decoy 900 can be used to implement inflatable radar decoys 110 in FIG. 1, inflatable radar decoys 210 in FIG. 2, and inflatable radar decoy 612 in FIGS. 6-8.

As depicted, inflatable radar decoy 900 is comprised of at least one of a biaxially-oriented polyethylene terephthalate film, a plastic sheet with a metallic coating, or some other suitable material. In this example, inflatable radar decoy 900 includes inflatable bladder 902. Inflatable bladder 902 can be inflated into an inflated state with a gas to have the shape of a sphere. Of course, in other illustrative examples, inflatable radar decoy 900 may have other shapes went inflated. These shapes include, for example, without limitation, a pyramid, a cube, an octahedron, a dodecahedron, a cylinder, or some other suitable shape.

In this example, interior 904 of inflatable bladder 902 is shown as transparent in places to show components in interior 904. As depicted, inflatable bladder 902 contains first radio frequency reflective circular sheet 906, second radio frequency reflective circular sheet 908, and third second radio frequency reflective circular sheet 909. These three sheets can be comprised of components selected from at least one of a biaxially-oriented polyethylene terephthalate film, a plastic sheet with a metallic coating, or some other suitable material that reflects radar signals at a desired frequency or frequency range. These materials are also selected as materials that can be folded, rolled, or otherwise stored within inflatable bladder 902 when inflatable bladder 902 is in an uninflated state within inflator cartridge 610 in FIG. 6.

In this illustrative example, first radio frequency reflective circular sheet 906, second radio frequency reflective circular sheet 908, and third radio frequency reflective circular sheet 909 intersect each other forming eight corner reflectors. As depicted, the eight corner reflectors comprise corner reflector 910, corner reflector 912, corner reflector 914, corner reflector 916, corner reflector 918, corner reflector 920, corner reflector 922, and corner reflector 924.

The illustration of inflatable radar decoy 900 in FIG. 9 is presented as one physical implementation of inflatable radar decoy 312 shown in block form in FIG. 3. This illustration is not meant to limit the manner in which other inflatable radar decoys may be implemented. For example, other inflatable radar decoys may have other shapes other than a sphere. For example, another inflatable radar decoy may have a shape of a cube, a cuboid, a pyramid, a cylinder, or some other suitable shape. As another example, other inflatable radar decoys may not employ corner reflectors. Other inflatable radar decoys may employ corner cubes or other types of reflector designs.

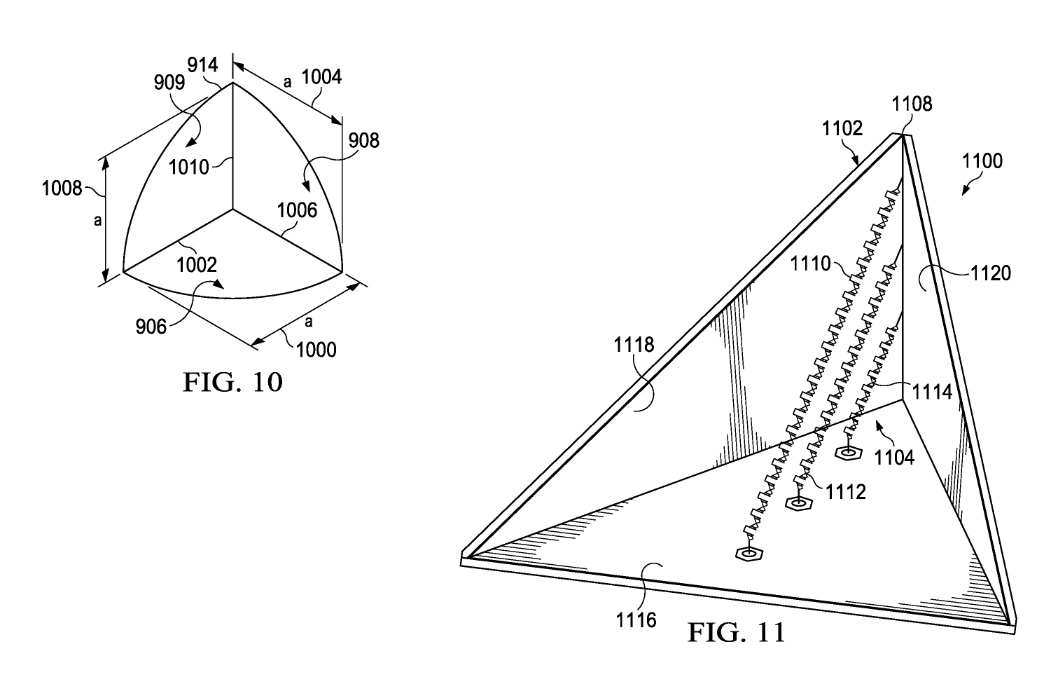

Turning to FIG. 10, an illustration of a corner reflector is depicted in accordance with an illustrative embodiment. In this figure, corner reflector 914 in inflatable bladder 902 is shown. Corner reflector 914 is a round corner reflector in this illustrative example. As depicted, corner reflector 914 has length 1000 on y-axis 1002, length 1004 on x-axis 1006, and length 1008 on z-axis 1010. In this example, length 1000, length 1004, and length 1008 are equal to “a”. The radar cross-section for corner reflector 914 in the form of a round corner reflector is defined as follows:

$$σ = \frac{15.6 {πα}^{4}}{3 {λ}^{2}}$$

wherein σ is the radar cross-section of the corner reflector, α is a radius of the corner reflector, and λ is a wavelength for a radar signal.

In the illustrative example, inflatable radar decoy 900 is comprised of materials selected to be relatively inexpensive, have broad frequency and angular coverage, and produce large radar returns from a relatively small package. For example, a peak radar cross-section of 1,000 m2 can be achieved from a 19-inch radius inflatable corner reflector, such as corner reflector 914 at 10 GHz (wavelength λ=3 cm) presenting a much larger target than the protected platform. For example, a large aircraft has an average radar cross-section that could range anywhere from 10 m2 nose-on to over 1,000 m2 on a broadside view.

Turning next to FIG. 11, an illustration of a Doppler shift mechanism is depicted in accordance with an illustrative embodiment. In this illustrative example, Doppler shift mechanism 1100 is formed using corner reflector 1102 and diode networks 1104. As depicted, corner reflector 1102 is comprised of a metallic sheet that can be packaged for use in an inflatable radar decoy such as inflatable radar decoy 312 in FIG. 3.

As depicted, diode networks 1104 is connected to planar member 1106 of corner reflector 1102. In this example, diode networks 1104 comprise a series of tuned, spaced diode networks configured to generate carrier suppressed Doppler sidebands in which each tuned, spaced diode networks in the series of tuned, spaced diode networks operates at a different frequency range. For example, diode networks 1104 comprise antenna 1110, antenna 1112, and antenna 1114 in which each of these antennas is connected together by a series of diodes.

In this illustrative example, diode networks 1104 is connected to planar member 1116 of corner reflector 1102. As depicted, diode networks 1104 is connected to intersection 1108 of planar member 1118 and planar member 1120. In this illustrative example, diode networks 1104 are designed to operate in a manner that modulates frequencies in response to a radar signal such that a Doppler shift occurs in the response to simulate one or more moving objects. These diode networks can be switched on and off at a desired frequency to generate a Doppler frequency shift. The switching may be performed using a switching circuit.

The illustration of Doppler shift mechanism 1100 is not meant to limit the manner in which other Doppler shift mechanisms may be implemented. For example, other Doppler shift mechanisms may have other numbers of diode networks that could be integrated onto the sides of the reflectors.

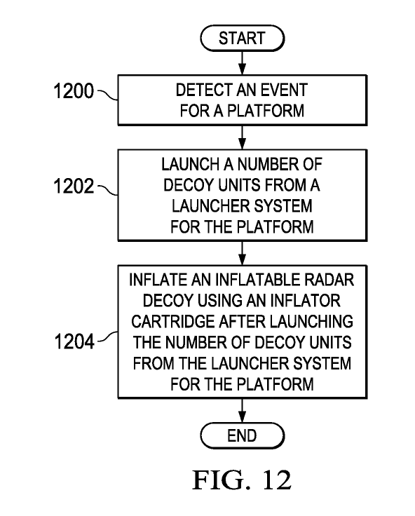

Turning next to FIG. 12, an illustration of a flowchart of a process for reflecting a radar signal is depicted in accordance with an illustrative embodiment. The process in the flowchart can be implemented in platform 302 in FIG. 3, surveillance aircraft 102 in FIG. 1, surface ship 202 in FIG. 2, or some other suitable platform.

The process begins by detecting an event for a platform (operation 1200). In operation 1200, the event can be any event for which a radar decoy may be needed. The event can be the detection of an object, such as a missile. In another illustrative example, the event can be the detection of a radar signal at the platform. In other illustrative examples, the event can be an operator sending a signal to launch one or more decoy units. For example, a pilot of an aircraft may launch decoy units as a precaution when approaching a hostile location.

Next, the process launches a number of decoy units from a launcher system for the platform (operation 1202). In operation 1202, a decoy unit comprises an inflatable radar decoy and an inflator cartridge configured to inflate the inflatable radar decoy.

The process inflates an inflatable radar decoy using an inflator cartridge after launching the number of decoy units from the launcher system for the platform (operation 1204). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware.

When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

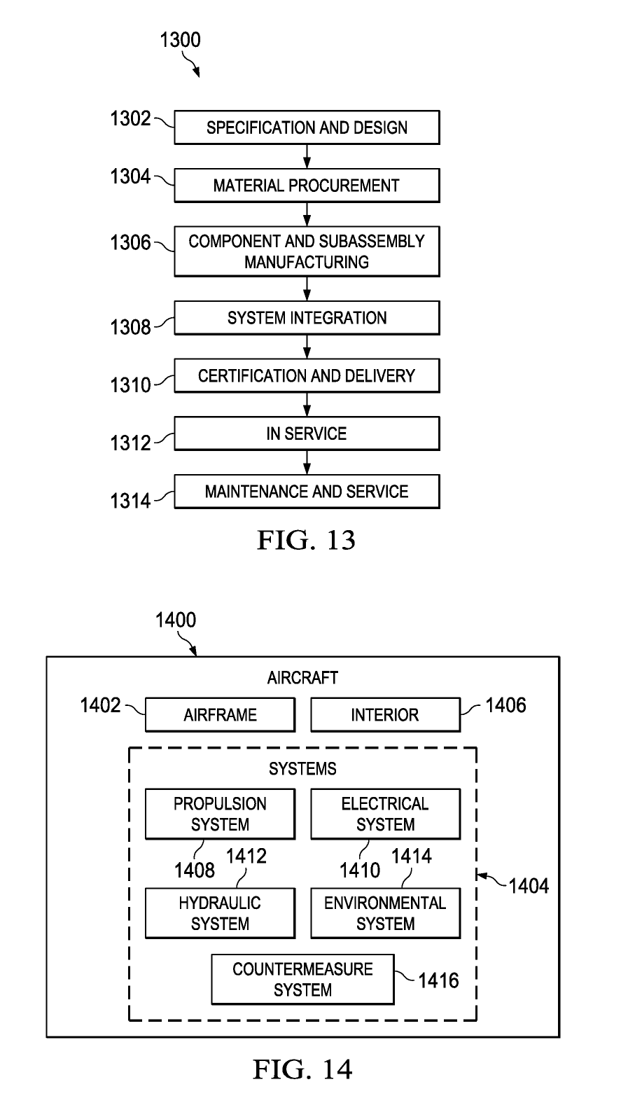

Illustrative embodiments of the disclosure may be described in the context of aircraft manufacturing and service method 1300 as shown in FIG. 13 and aircraft 1400 as shown in FIG. 14. Turning first to FIG. 13, an illustration of a block diagram of an aircraft manufacturing and service method is depicted in accordance with an illustrative embodiment. During pre-production, aircraft manufacturing and service method 1300 may include specification and design 1302 of aircraft 1400 in FIG. 14 and material procurement 1304.

During production, component and subassembly manufacturing 1306 and system integration 1308 of aircraft 1400 in FIG. 14 takes place. Thereafter, aircraft 1400 may go through certification and delivery 1310 in order to be placed in service 1312. While in service 1312 by a customer, aircraft 1400 is scheduled for routine maintenance and service 1314, which may include modification, reconfiguration, refurbishment, and other maintenance or service.

Each of the processes of aircraft manufacturing and service method 1300 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 14, an illustration of a block diagram of an aircraft is depicted in which an illustrative embodiment may be implemented. In this example, aircraft 1400 is produced by aircraft manufacturing and service method 1300 in FIG. 13 and may include airframe 1402 with plurality of systems 1404 and interior 1406. Examples of systems 1404 include one or more of propulsion system 1408, electrical system 1410, hydraulic system 1412, environmental system 1414, and countermeasure system 1416. For example, radar countermeasure system 304 in FIG. 3 may be implemented as one or more countermeasure mechanisms in countermeasure system 1416.

Any number of other systems may be included. Although an aerospace example is shown, different illustrative embodiments may be applied to other industries, such as the automotive industry. Apparatuses and methods embodied herein may be employed during at least one of the stages of aircraft manufacturing and service method 1300 in FIG. 13.

In one illustrative example, components or subassemblies produced in component and subassembly manufacturing 1306 in FIG. 13 may be fabricated or manufactured in a manner similar to components or subassemblies produced while aircraft 1400 is in service 1312 in FIG. 13. As yet another example, one or more apparatus embodiments, method embodiments, or a combination thereof may be utilized during production stages, such as component and subassembly manufacturing 1306 and system integration 1308 in FIG. 13. One or more apparatus embodiments, method embodiments, or a combination thereof may be utilized while aircraft 1400 is in service 1312, during maintenance and service 1314 in FIG. 13, or both.

For example, radar countermeasure system 304 can be implemented in aircraft 1400 during at least one of component and subassembly manufacturing 1306, system integration 1308, or maintenance and service 1314. For example, a radar countermeasure system can be implemented during operation such as refurbishment, modification, reconfiguration or reconfiguration of aircraft 1400.

The use of a number of the different illustrative embodiments may substantially expedite the assembly of aircraft 1400, reduce the cost of aircraft 1400, or both expedite the assembly of aircraft 1400 and reduce the cost of aircraft 1400.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Thus, one or more illustrative examples provide a technical solution that includes a radar decoy that is launched from a launcher system. The launcher system can be implemented with currently used launcher systems already employed to launch other objects such as chaff or flares. When the systems are already installed in a platform such as an aircraft, installation of a new launcher system or costly modifications can be reduced or avoided.

In one illustrative example, the decoy unit comprises an inflator cartridge and an inflatable radar decoy. The inflator cartridge is configured to inflate the inflatable radar decoy using at least one of a compressed gas, a chemical, or some other mechanism that causes the inflatable radar decoy to inflate as quickly as possible when deployed from the launcher system.

Thus, one or more technical solutions are present with a technical effect reducing integration costs and providing for rapid inflation of inflatable radar decoys. Further, in some illustrative examples reflectors also may be implemented to provide a desired radar cross-section a platform.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A radar countermeasure system that comprises:
a decoy unit that comprises an inflatable radar decoy within an inflator cartridge configured to inflate and then separate from the inflatable radar decoy, such that the inflator cartridge comprises a size and a shape configured to launch from one of: a flare slot, or a chaff slot, of a launcher system, associated with a platform, configured to hold and launch a number of decoy units.

2. The radar countermeasure system of claim 1, wherein the inflatable radar decoy comprises:
an inflatable bladder that is radio frequency transparent; and
a number of radio frequency reflective sheets attached to an interior of the inflatable bladder.

3. The radar countermeasure system of claim 2, wherein the number of radio frequency reflective sheets comprises:
a first radio frequency reflective circular sheet;
a second radio frequency reflective circular sheet; and
a third radio frequency reflective circular sheet, wherein the first radio frequency reflective circular sheet, the second radio frequency reflective circular sheet, and the third radio frequency reflective circular sheet are intersected with each other to form eight corner reflectors within the inflatable bladder in which edges of the eight corner reflectors are attached to an inside surface of the inflatable bladder such that the eight corner reflectors are formed when the inflatable bladder is inflated.

4. The radar countermeasure system of claim 3, wherein a radar cross-section of a corner reflector, of the eight corner reflectors, is defined as follows:
$$σ = \frac{15.6 {πα}^{4}}{3 {λ}^{2}}$$
wherein σ is the radar cross-section of the corner reflector, α is a radius of the corner reflector, and λ is a wavelength for a radar signal.

5. The radar countermeasure system of claim 1, wherein the inflatable radar decoy comprises:
an inflatable bladder that is radio frequency transparent; and
a number of corner reflectors located inside of the inflatable bladder.

6. The radar countermeasure system of claim 5 further comprising:
a Doppler shift mechanism connected to a corner reflector in the number of corner reflectors, wherein the Doppler shift mechanism generates a response to a radar signal in which the response includes a Doppler frequency shift that mimics movement of a target.

7. The radar countermeasure system of claim 6, wherein the Doppler shift mechanism comprises a series of tuned, spaced diode networks for generating carrier suppressed Doppler sidebands in which each tuned, spaced diode network in the series of tuned, spaced diode networks operates at a different frequency range.

8. The radar countermeasure system of claim 1, wherein the inflator cartridge is configured to inflate the inflatable radar decoy with a gas selected from a group comprising air, nitrogen, helium, and argon.

9. The radar countermeasure system of claim 1, wherein the launcher system is further configured to hold and launch at least one of a chaff or a flare in addition to the number of decoy units.

10. The radar countermeasure system of claim 1, wherein the inflatable radar decoy is comprised of at least one of a biaxially-oriented polyethylene terephthalate film and a plastic sheet with a metallic coating.

11. The radar countermeasure system of claim 1, wherein the inflatable radar decoy has a shape selected from a group comprising a sphere, a pyramid, a cube, an octahedron, a dodecahedron, and a cylinder.

12. The radar countermeasure system of claim 1, wherein the platform is selected from a group comprising a mobile platform, a stationary platform, a land-based structure, an aquatic-based structure, a space-based structure, an aircraft, a surface ship, a tank, a personnel carrier, a train, a spacecraft, a space station, a satellite, a submarine, a power plant, a bridge, a dam, a manufacturing facility, and a building.

13. A radar countermeasure system that comprises a number of decoy units, such that a decoy unit in the number of decoy units comprises:
an inflator cartridge that comprises a size and a shape configured to launch from one of: a chaff slot, or a flare slot, in a launcher; and
an inflatable radar decoy stored within the inflator cartridge that comprises a size and a shape configured to launch from one of: a chaff slot, or a flare slot, in a launcher, and configured to inflate and then separate from the inflatable radar decoy, such that the inflatable radar decoy comprises:
an inflatable bladder that is radio frequency transparent; and
a number of corner reflectors located inside of the inflatable bladder.

14. The radar countermeasure system of claim 13, wherein the inflatable radar decoy comprises:
the inflatable bladder; and
a Doppler shift mechanism within the inflatable bladder, wherein the Doppler shift mechanism is configured to generate a response to a radar signal in which the response includes a Doppler frequency shift that mimics movement of a target when the inflatable bladder is inflated.

15. The radar countermeasure system of claim 13, wherein the inflatable radar decoy comprises:
the inflatable bladder;
a first radio frequency reflective circular sheet;
a second radio frequency reflective circular sheet; and
a third radio frequency reflective circular sheet, wherein the first radio frequency reflective circular sheet, the second radio frequency reflective circular sheet, and the third radio frequency reflective circular sheet are intersected with each other to form corner reflectors within the inflatable bladder in which edges of the corner reflectors are attached to an inside surface of the inflatable bladder such that the corner reflectors are formed when a sphere is inflated.

16. The radar countermeasure system of claim 13, wherein a radar cross-section of a corner reflector in the corner reflectors is defined as follows:
$$σ = \frac{15.6 {πα}^{4}}{3 {λ}^{2}}$$
wherein σ is the radar cross-section of the corner reflector, a is a radius of the corner reflector, and λ is a wavelength for a radar signal.

17. A method for reflecting a radar signal, the method comprising:
detecting an event prompting deploying a radar decoy from a platform;
storing an inflatable radar decoy within an inflator cartridge comprising a size and a shape for launching the inflator cartridge from a chaff slot or a flare slot in a launcher system for the platform;
launching a decoy unit, comprising the inflator cartridge, from the launcher system for the platform
inflating the inflatable radar decoy using the inflator cartridge after launching the decoy unit from the chaff slot or the flare slot in the launcher system for the platform; and
after inflating the inflatable radar decoy, detaching and discarding the inflator cartridge from the inflatable radar decoy.

18. The method of claim 17, wherein the inflatable radar decoy comprises:
an inflatable bladder that is radio frequency transparent; and
a number of corner reflectors located inside of the inflatable bladder.

19. The method of claim 18, wherein a radar cross-section of a corner reflector in the number of corner reflectors is defined as follows:
$$σ = \frac{15.6 {πα}^{4}}{3 {λ}^{2}}$$
wherein σ is the radar cross-section of the corner reflector, α is a radius of the corner reflector, and λ is a wavelength for the radar signal.

20. The method of claim 17, further comprising:
generating a response to the radar signal in which the response includes a Doppler frequency shift that mimics movement of a target utilizing a Doppler shift mechanism.
